(19) United States
(12) Patent Application Publication
(10) Pub. No.: US 2005/0198685 A1
(43) Pub. Date: Sep. 8, 2005

(54) Method and system for automatic support for multiple DOCSIS versions in a user device

(76) Inventor: Allen Walston, Atlanta, GA (US)

Correspondence Address: ARRIS INTERNATIONAL, INC, 3871 LAKEFIELD DRIVE, SUWANEE, GA, 30024, US

(21) Appl. No.: 11/046,948

(22) Filed: Jan. 31, 2005

Related U.S. Application Data
(60) Provisional application No. 60/481,967, filed on Jan. 29, 2004.

(51) Int. Cl. H04N 7/173

(52) U.S. Cl. 725/111

(57) ABSTRACT

Default software is configured at manufacture to operate in DOCSIS 1.0/1.1 mode. When communication is established between a CMTS, or other similar device, and a cable modem, or other similar device, UCDs are collected. If no UCD is collected that refers to a upstream channel associated with DOCSIS 2.0, then the device continues to register as a DOCSIS 1.0/1.1 device. If a collected UCD refers to an upstream channel having components associated with DOCSIS 2.0, then the device stores the current downstream channel frequency, overwrites the stored DOCSIS 1.1 flag with a DOCSIS 2.0 value, and shuts down. Upon restart, the stored channel frequency is tuned, the DOCSIS 2.0 mode is used, and the boot process continues in DOCSIS 2.0 mode.

### CROSS REFERENCE TO RELATED APPLICATION

This application claims priority under 35 U.S.C. 119(e) to U.S. provisional patent application No. 60/481,967 entitled “Autodetect DOCSIS 2.0”, which was filed Jan. 29, 2004, and is incorporated herein by reference in its entirety.

### FIELD OF THE INVENTION

This invention relates, generally, to communication devices and, more particularly, to facilitating improved interoperation between central office and customer premise devices, such as, for example, cable modems in a DOCSIS™ or EuroDOCSIS™ network.

### BACKGROUND

Network interface devices, such as, for example, cable modems, are one way that multiple services operators (“MSO”) have been meeting the demand for increased bandwidth capabilities in delivering information over networks from a central location, such as a head end, to users, such as residential and commercial end users. To facilitate such information delivery, standards have been developed that allow equipment from different manufacturers to operate, or ‘talk,’ with one another. The predominant standard used in the cable modem industry is known as Data Over Cable Service Interface Specification, or (“DOCSIS”), for use in delivering digital data, such as internet information, to users over the existing coaxial lines of the Community Antenna Television system (“CATV”), which has been delivering cable television programming to users at least since the 1960's.

Currently, there are multiple versions of the DOCSIS and EuroDOCSIS specifications that are in widespread use around the world. As a result, customer premise equipment (“CPE”) must negotiate through messaging with central office equipment, such as, for example, cable modem termination systems (“CMTSs”) to determine which version of the specification will be used.

At the time when version 1.0 of DOCSIS was being developed, version 1.1 was on the horizon. Consequently, vendors developing DOCSIS 1.0 devices generally took into the account the possibility of having to interoperate with a DOCSIS 1.1 piece of equipment. Some vendors did not, however, take into account the possibility that there might be newer versions of the specification, which would result in newer devices, such as DOCSIS2.0, connected to them. As a result, some DOCSIS 1.0 CMTSes will not interoperate with a DOCSIS 2.0 CPE. As a result, it is sometimes necessary for a CPE to behave as a DOCSIS 1.0 or DOCSIS 1.1 device, even though the CPE is capable of using DOCSIS 2.0. Most CPE vendors control this behavior with a setting that is stored in nonvolatile memory during the manufacturing process. If this setting needs to be changed after the CPE has left the factory, the Simple Network Management Protocol (“SNMP”) is typically used to change it.

A disadvantage with this is that if the CPE behaves as a DOCSIS 1.0 or DOCSIS 1.1 device, it will be incapable of interoperating with a CMTS running DOCSIS 2.0 in certain configurations. Therefore, CPE vendors determine what version of DOCSIS their equipment should use when that equipment is delivered to customers.

The CPE can determine whether or not the CMTS is using DOCSIS 2.0 by examining the contents of the Upstream Channel Descriptors (“UCDs”) that the CMTS transmits periodically. These UCDs describe the physical characteristics of the upstream channels that the CPE can use to attempt to communicate with the CMTS. These characteristics include the symbol rate, RF frequency and modulation profile for the CPE to use. One of the largest changes in the 2.0 version of the DOCSIS specification is the addition of new modulation profiles for the CPE to use. If all of the UCDs sent by a DOCSIS 2.0 CMTS call for the use of these new modulation profiles, and the CPE is configured to run only in DOCSIS 1.0/1.1 mode, then the CPE will not be able to interoperate with the CMTS.

Accordingly, there is a need for a method and system for facilitating a cable modem in recognizing whether a CMTS to which it connects uses a higher version of DOCSIS than is currently configured on the cable modem. It will be appreciated that this process is used in DOCSIS systems, but other communication applications may also use an automatic protocol detection routine.

### SUMMARY

It is an object to provide a method for providing CPE devices from a manufacturing factory to the customer configured in such a way that they will work successfully on a CATV plant no matter which version of the DOCSIS specification is being employed by the CMTS(s) on that plant.

The CPE is configured at manufacturing and shipped to default to DOCSIS 1.1 mode so that it will interoperate with all older CMTSes found in MSO's CATV plants. After the modem tunes to a downstream signal from a CMTS it collects the UCDs. If a collected UCD describes an upstream channel that uses SCDMA or ATDMA (Advanced Time Division Multiple Access) modulation profiles, which are used in DOCSIS 2.0, then the modem will automatically switch modes and start working as a DOCSIS 2.0 device. This allows it to automatically work with, a CMTS running any version of the DOCSIS specification.

### BRIEF DESCRIPTION OF DRAWINGS

FIG. 1 shows a flow chart illustrating the steps taken by the modem to decide what version of DOCSIS it needs to support.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

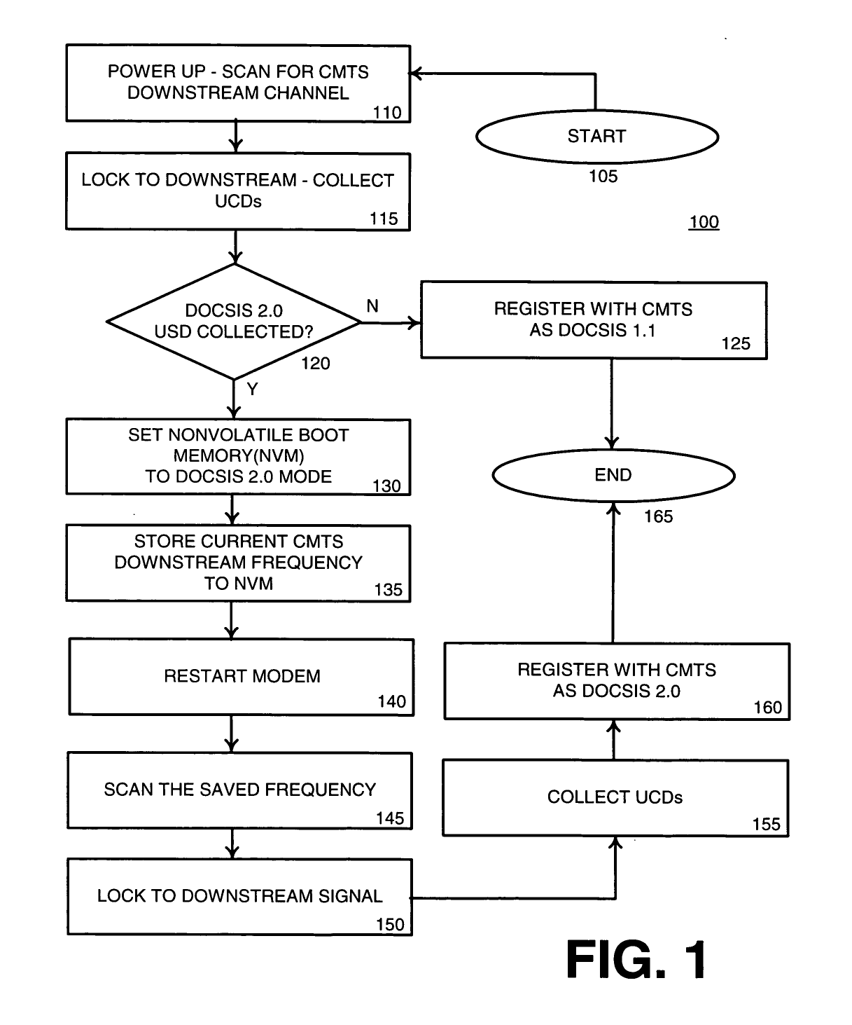

Turning now to the figures, as discussed above, FIG. 1 illustrates a method 100 for initializing a cable modem by automatically detecting whether a CMTS to which it is attempting to connect is a DOCSIS 1.0/1.1 or a DOCSIS 2.0 system. Method 100 starts at step 105 and powers up at step 110 and searches for a downstream channel frequency. When a downstream channel is sensed at step 110, the modem locks to the sensed frequency at step 115 and collects upstream channel descriptors (“UCD”). At step 120, the method determines whether a DOCSIS 1.0/1.1 or a DOCSIS 2.0 UCD was collected.

This determination may be made by evaluating the information contained in the UCD. For example, if the type field is set to a value that is reserved for DOCSIS 2.0 UCDs, or if the modulation profile associated with a collected UCD refers to SCDMA or Advanced Time Division Multiple Access (“ATDMA”), then the modem or other similar device assumes that the CMTS is a DOCSIS 2.0 system, because only DOCSIS 2.0 systems use these type fields or modulation schemes. If one of these types or modulation schemes is not associated with a UCD collected at step 115, then the modem assumes that the CMTS is a DOCSIS 1.0/1.1 system, and registers with the CMTS accordingly at step 125.

If a DOCSIS 2.0 modulation scheme is discovered to be associated with a collected UCD, a DOCSIS 2.0 flag is set in non-volatile memory (“NVM”) at step 130. The current CMTS downstream frequency to which the modem is tuned is stored to NVM at step 135, and the modem is restarted at step 140. The cable modem uses the stored DOCSIS 2.0 flag loaded in prior to restart to configure itself as a DOCSIS 2.0 device, and retrieves the saved downstream channel frequency at step 145. The modem locks to the downstream signal at the saved signal frequency at step 150, and collects UCDs at step 155. When the upstream channel descriptors have been retrieved at step 155, the modem registers with the CMTS in DOCSIS 2.0 mode at step 160 and the process ends at step 165.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A method for automatically detecting a DOCSIS version used by a CMTS on a network, comprising:
configuring a cable modem to operate according to DOCSIS 1.0/1.1;
tuning to a downstream channel on the network;
collecting UCDs;
determining whether a collected UCD refers to a DOCSIS 2.0 upstream channel; and
storing DOCSIS 2.0 flag to non-volatile memory if it is determined that the UCD refers to a DOCSIS 2.0 upstream channel.

2. The method of claim 1 wherein a collected UCD refers to a DOCSIS 2.0 upstream channel, further comprising:
storing the current downstream channel frequency to NVM;
restarting modem using the DOCSIS 2.0 flag stored in non-volatile memory;
tuning to the stored downstream channel frequency;
collecting UCDs; and
registering with the CMTS as a DOCSIS 2.0 cable modem.

3. The method of claim 1 wherein no collected UCDs refer to a DOCSIS 2.0 upstream channel, further comprising:
registering with the CMTS as a DOCSIS 1.0/1.1 cable modem.
